(19) United States
(12) Patent Application Publication
(10) Pub. No.: US 2016/0364725 A1
(43) Pub. Date: Dec. 15, 2016

(54) METHODS AND SYSTEMS FOR REPORTING TRANSACTION ISSUES

(71) Applicant: MASTERCARD INTERNATIONAL INCORPORATED, Purchase, NY (US)

(72) Inventors: Derek Corcoran, Dublin (IE); Ali Boujtat, Steenkkerzeel (BE); Mehul Patel, Vadodara (IN); Medha Bhatt, Bridgewater, NJ (US); Subrahmanyam Musti, Scarsdale, NY (US); Marc Van Puyvelde, Bornem (BE)

(21) Appl. No.: 15/179,180

(22) Filed: Jun. 10, 2016

(30) Foreign Application Priority Data
Jun. 12, 2015 (GB) 1510347.6

(51) Int. Cl. G06Q 20/40; G06Q 10/10; G06Q 20/32

(52) U.S. Cl. CPC G06Q 20/401; G06Q 20/3224; G06Q 10/1095

(57) ABSTRACT

Methods and systems of collating and transmitting information relating to a payment transaction are provided. Current location of the mobile device is determined and merchant data, concerning merchants located within a predetermined distance of the current location of the mobile device is obtained. A list of merchants is generated based on the merchant data and presented on the mobile device. The user is requested to select a merchant from the list of merchants and input data in relation to the payment transaction through the user interface of the mobile electronic device, which requires the input data to be in a predetermined format. The mobile device generates a transaction report, based on the input data and merchant data associated with the merchant selected by the user, in a format compliant with requirements of a backend server and then transmits the transaction report towards the backend server for automatic processing.

### CROSS-REFERENCE TO RELATED APPLICATION

This application claims the benefit of, and priority to, Great Britain Patent Application No. 1510347.6 filed Jun. 12, 2015. The entire disclosure of the above application is incorporated herein by reference.

### FIELD

This disclosure relates generally to information acquisition and transmissions relating to payment processes. In particular, but not exclusively, the disclosure relates to methods of acquiring transaction data relating to failed payment transactions and providing the information automatically to a backend server of a payment network provider to allow the payment network provider to determine the causes of the failure.

### BACKGROUND

This section provides background information related to the present disclosure which is not necessarily prior art.

Most modern day monetary transactions use what is known as a payment processing network. An example of such a network is the MasterCard™ operated Banknet™, one of the world's largest global telecommunications networks which links all MasterCard™ members and MasterCard™ data processing centres into a single financial network. Banknet™ facilitates the routing of transactions for authorization and their clearing from almost anywhere in the world.

Such payment networks form an integral part of what is commonly known as a “four-party” or “open loop” payment system because transfers via the system may occur between two financial institutions (serving respective customers) that do not have a contractual relationship with each other but rather are members of the system. The four parties are: an account holder or a representative of an account holder; a merchant; an issuing financial institution; and an acquiring financial institution.

The account holder is a customer of the issuing financial institution who is typically provided with a payment device by said financial institution, commonly in the form of an Integrated Circuit Card (ICC) such as a MasterCard™ payment card. The role of the payment device is to provide both the necessary information required for processing of a transaction and the appropriate level of security. Verification of the payment device holder is used to evaluate whether the person presenting the payment device is the legitimate holder of said device.

The merchant is typically a seller of goods or services and is a customer of the acquiring financial institution. The payment network acts as a fifth party which links the four parties involved in each payment process, thereby facilitating the transaction.

A transaction can fail as a result of a technical issue with any of the parties involved in the payment system. It is possible that the party responsible for the technical issue is not the same party that first becomes aware of the failure of the transaction. For example, an account holder may attempt to purchase goods from a merchant, only for the payment to fail due to a fault in the systems of the payment network or one of the financial institutions; the account holder and merchant may immediately become aware of the failure without the payment network being notified that an issue has arisen. In such a scenario, the account holder is unlikely to know which of the parties in the transaction has suffered a technical difficulty or inform the payment network about the problem and the payment network provider may remain unaware of the issue and therefore allow the problem to persist.

When a transaction issue, such as the failure of a transaction, occurs, the customer involved in the transaction often informs their bank of the issue. The details of the transaction issue are then provided by the bank to the payment network provider. If the payment network provider requires further information in order to resolve the issue, the payment network provider must request more details from the bank. The bank may, in turn, have to request further details from the account holder.

Even if sufficient transaction details are provided by the customer initially, they may be provided in such a format that significant human input is required to interpret them; for instance, the customer may provide a commonly used name for a given merchant rather than the name used by the payment network provider.

Furthermore, the transaction details provided by the customer to the bank are likely to be based on the customer's recollection of the event at a later time and, therefore, of unreliable accuracy.

Customers are often unaware of procedures for reporting transaction issues or consider reporting a transaction issue to be an inconvenience. When this is the case, both the customer's bank and the payment network provider may remain unaware of the transaction issue.

It is of vital importance for the provider of a payment network to determine the causes of any failed transactions. When an issue with a transaction is reported, the payment network must ascertain whether the cause of the issue can be accounted for by a previously known technical fault, or, conversely, if a fault in the systems of the payment network can be ruled out as a cause.

In order to determine the technical cause of a given transaction issue, the payment network provider must be able to map the details of a payment transaction onto data concerning the state of the payment network system. For example, it may be known that a network fault affected merchants in a certain region for a short period of time; this fault can then be mapped onto an account for transaction issues that occurred for a customer in that area at that time.

A system and method is needed in which data pertinent to an issue relating to a transaction can be quickly and accurately acquired and automatically provided to a payment network provider for analysis and comparison with systems data relating to the state of the technical systems belonging to the payment providers.

### SUMMARY

This section provides a general summary of the disclosure, and is not a comprehensive disclosure of its full scope or all of its features. Aspects and embodiments of the disclosure are also set out in the accompanying claims.

The present disclosure provides a computer implemented method of collating and transmitting information relating to a payment transaction. The method is executed by a mobile electronic device and comprises: determining, at a mobile electronic device, a current location of the mobile electronic device; obtaining merchant data, by the mobile electronic device, concerning one or more merchants located within a predetermined distance from the current location of the mobile electronic device; generating, by the mobile electronic device, a list of merchants based on the merchant data; receiving, through a user interface of the mobile electronic device, a user selection of a merchant from the list of merchants; requesting, through a prompt presented on a display of the mobile electronic device, input data from a user in relation to a plurality of aspects of the payment transaction; receiving, through the user interface of the mobile electronic device, input data provided by a user in relation to a plurality of aspects relating to the payment transaction, wherein for each aspect of the plurality of aspects relating to the payment transaction the user interface is configured to require the input data to be in a predetermined format; generating, by the mobile electronic device, a transaction report, based on the input data and merchant data associated with the merchant selected by the user, in a format compliant with requirements of a backend server; and transmitting the transaction report from the mobile electronic device towards the backend server for automatic processing.

The above features provide several advantages over commonly used procedures for reporting issues relating to payment transactions. Requiring a user to input data relating to aspects of the payment in a predetermined format enables the network payment provider to design and use systems for efficiently analysing the transaction report and comparing the data included therein with their records.

Making certain data fields mandatory when reporting an issue also has great benefits to the payment network provider in terms of having the correct information available to analyse and resolve an acceptance issue right from the time of the initial report.

The use of automatically filled data fields increases the accuracy of transaction data provided to payment network providers while decreasing the time burden for users reporting issues.

In some example embodiments, the method further comprises: determining a current date automatically using an inbuilt calendar feature of the mobile electronic device and determining a current time using an inbuilt clock feature of the mobile electronic device, and wherein the transaction report further comprises data indicating the determined current date and the determined current time.

In some example embodiments, obtaining merchant data comprises transmitting a merchant information data request to a remote server hosting a database comprising merchant information data, the merchant information data request comprising data identifying the current location of the mobile electronic device; and receiving from the remote server, in response to the merchant information data request, merchant data comprising the names and addresses of one or more merchants within a predetermined distance of the current location of the mobile electronic device identified in the merchant information data request.

In some example embodiments, the method further comprises: presenting the list of merchants to the user in the form of a drop down list on a display of the mobile electronic device; and wherein the user selection of a merchant from the list of merchants is received in response to presenting the list of merchants to the user.

In some example embodiments, generating the transaction report comprises generating a report message wherein a main body of the report message comprises the input data and the merchant data associated with the merchant selected by the user arranged according to a predetermined format.

In some example embodiments, the predetermined format of the report message defines the order in which the input data and merchant data are presented in the transaction report.

In some example embodiments, the predetermined format of the report message further determines the form in which the data relating to each aspect of the transaction is presented in the transaction report.

In some example embodiments, the method further comprises: prompting the user, via the user interface, to take a photograph of the point of interaction terminal; accessing a camera control software comprised by the mobile electronic device; and initiating, using the camera control software, a camera of the mobile electronic device in order to obtain an image of the point of interaction terminal; wherein: the transaction report further comprises the obtained image of the point of interaction terminal.

In some example embodiments, the method further comprises: prompting the user, via the user interface, to take a photograph of a receipt issued upon failure of the transaction; accessing a camera control software comprised by the mobile electronic device; and initiating, using the camera control software, a camera of the mobile electronic device in order to obtain an image of the receipt; wherein: the transaction report further comprises the obtained image of the receipt.

In some example embodiments, the method further comprises: processing the image of the point of interaction terminal or the receipt using text recognition software stored on the mobile electronic device to extract text data corresponding to writing displayed on the point of interaction terminal or the receipt, and wherein the transaction report further comprises the text data.

In some example embodiments, the mobile electronic device is a smartphone.

In some example embodiments, the transaction report is in the form of an email message addressed to a predetermined recipient address.

In some example embodiments, the predetermined format in which the input data is required comprises at least one of: a BIN number having exactly six digits identifying a payment card used in the payment transaction; a PAN number having exactly four digits identifying the payment card used in the payment transaction; an alphanumeric sequence corresponding to a message displayed by a terminal used in the payment transaction; an alphanumeric sequence corresponding to a message appearing on a receipt issued during the payment transaction; an alphanumeric sequence corresponding to comments provided by the merchant involved in the payment transaction; and/or an alphanumeric sequence corresponding to additional comments provided by the user.

Another aspect of the disclosure provides a mobile electronic device comprising: a communication node, a positioning system, a display, and a user interface wherein the mobile electronic device is configured to: determine a current location of the mobile electronic device using the positioning system; obtain merchant data concerning one or more merchants located within a predetermined distance from the current location of the mobile electronic device; generate a list of merchants based on the merchant data; receive, through the user interface, a user selection of a merchant from the list of merchants; request, through a prompt presented on a display of the mobile electronic device, input data from a user in relation to a plurality of aspects of the payment transaction; receive, through the user interface, input data provided by the user in relation to a plurality of aspects relating to the payment transaction, wherein for each aspect of the plurality of aspects relating to the payment transaction the user interface is configured to require the input data in a predetermined format; generate a transaction report based on the input data and merchant data associated with the merchant selected by the user, in a format compliant with requirements of a backend server; and transmit the transaction report from the communication node towards the backend server for automatic processing.

In some example embodiments, the mobile electronic device comprises an inbuilt calendar feature and an inbuilt clock feature, and wherein the mobile electronic device is further configured to: determine a current date automatically using an inbuilt calendar feature of the mobile electronic device and determining a current time using an inbuilt clock feature of the mobile electronic device, and wherein the transaction report further comprises data indicating the determined current date and the determined current time.

In some example embodiments, obtaining merchant data comprises transmitting a merchant information data request to a remote server hosting a database comprising merchant information data, the merchant information data request comprising data identifying the current location of the mobile electronic device; and receiving from the remote server, in response to the merchant information data request, merchant data comprising the names and addresses of one or more merchants within a predetermined distance of the current location of the mobile electronic device identified in the merchant information data request.

In some example embodiments, the mobile electronic device is further configured to: present the list of merchants to the user in the form of a drop down list on the display; and wherein the user selection of a merchant from the list of merchants is received in response to presenting the list of merchants to the user.

In some example embodiments, generating the transaction report comprises generating a report message wherein a main body of the report message comprises the input data and the merchant data of the merchant selected by the user arranged according to a predetermined format.

In some example embodiments, the predetermined format of the report message defines the order in which the input data and merchant data are presented in the transaction report; and the predetermined format of the report message further defines the form in which the data relating to each aspect of the transaction is presented in the transaction report.

In some example embodiments, the mobile electronic device is further configured to: prompt the user, via the user interface, to take a photograph of a receipt issued upon failure of the transaction or a point of interaction terminal; and access a camera control software comprised by the mobile electronic device; and initiate, using the camera control software, a camera of the mobile electronic device in order to obtain an image of the receipt; wherein: the transaction report further comprises said image of the receipt.

Further areas of applicability will become apparent from the description provided herein. The description and specific examples and embodiments in this summary are intended for purposes of illustration only and are not intended to limit the scope of the present disclosure. In addition, the above and other features will be better understood with reference to the followings Figures which are provided to assist in an understanding of the present teaching.

### DRAWINGS

The drawings described herein are for illustrative purposes only of selected embodiments and not all possible implementations, and are not intended to limit the scope of the present disclosure.

FIG. 1 is a flow diagram of communication channels used when reporting a payment issue conventionally;

FIG. 2 is a schematic representation of a mobile electronic device suitable for use in some examples of the disclosure;

FIG. 3 is a schematic representation of a system suitable for use in some examples of the disclosure;

FIG. 4 is a flow diagram showing a method according to an example of the disclosure;

FIG. 5 is an example of a user interface presented to a user in examples of the disclosure;

FIG. 6 is another example of a user interface presented to a user in examples of the disclosure;

FIG. 7 is another example of a user interface presented to a user in examples of the disclosure;

FIG. 8 is another example of a user interface presented to a user in examples of the disclosure;

FIG. 9 is another example of a user interface presented to a user in examples of the disclosure.

FIG. 10 is another example of a user interface presented to a user in examples of the disclosure.

FIG. 11 is an example of a user interface presented to a user in examples of the disclosure.

FIG. 12 is an example of a transaction reporting message according to examples of the disclosure.

Corresponding reference numerals generally indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

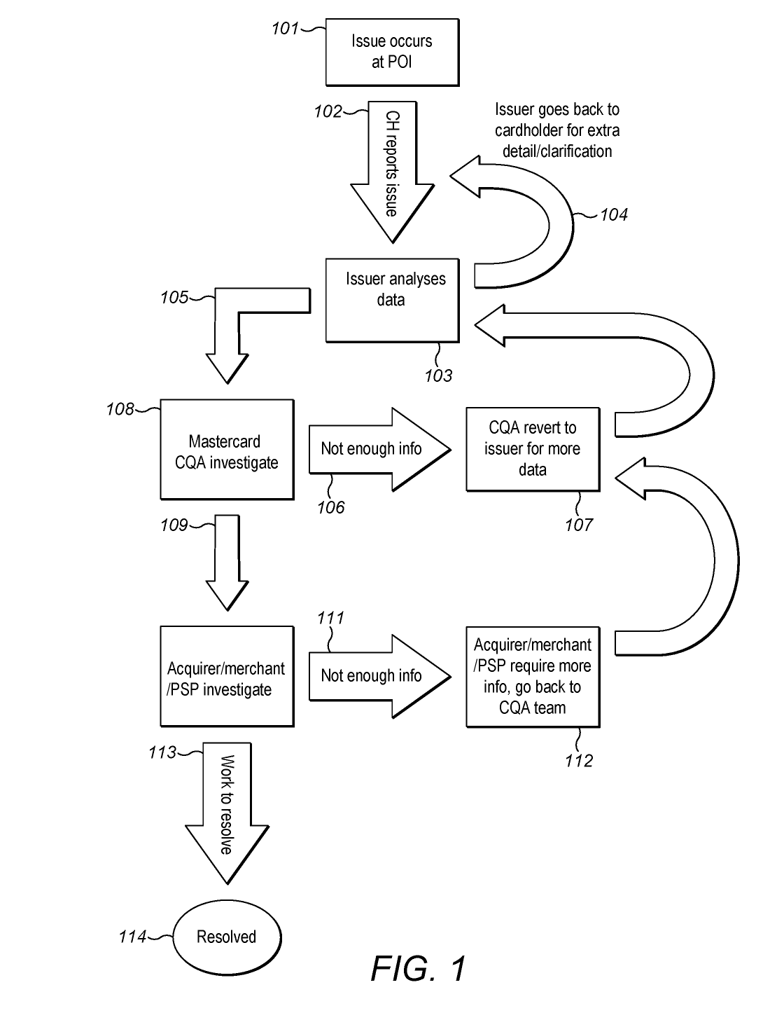

FIG. 1 shows a flow diagram illustrating conventional communication channels used when reporting and providing details of a payment issue, such as the failure of an attempted transaction, to a provider of payment networks. Such issues include, but are not limited to, the failure of a transaction, a payment surcharge, the failure of a payment card to initiate a transaction, or the refusal of cards using a particular payment network.

When an issue occurs at a point of interaction with a payment transaction involving a payment card (step 101), the cardholder (if she/he decides to report the issue at all) will usually report the details of the payment transaction to her/his card issuer (step 102), which will usually be a bank or another financial institution. This initial report may take the form of a phone call or email. As the user is unlikely to be presented with detailed prompts, the form and content of the initial reports submitted by users varies greatly.

The card issuer will then analyse the initial report (step 103). If the initial report requires further detail/clarification, the card issuer will return to the cardholder to request the additional information (step 104).

If the card issuer is satisfied that the initial report includes sufficient detail, the card issuer will send the report to the support team of a payment network provider, such as the MasterCard Customer Quality Acceptance (CQA) team (step 105). If the support team require more information (step 106), they will revert to the card issuer for more data (step 107), who may in turn revert to the cardholder (step 104).

If the support team of a payment network provider is satisfied that they now have enough information to determine the cause of the issue, a determination is made as to whether the cause lies within the systems of the payment network provider. If the support team determines that the cause lies within the systems of the payment network provider, works directed to remove the cause are put in place (step 113), resulting in the issue being resolved internally to the payment network provider (step 114).

However, if the support team determines that the cause of the issue is further downstream or it is a shared issue, the payment network provider contacts the respective acquirer, payment service provider (PSP), or merchant with the report for further investigation (step 109). If the acquirer (PSP or merchant) requires more information (step 111) to determine the cause, they will revert to the payment network provider for more data (step 112), who may in turn revert to the issuer (step 107), who then may revert to the cardholder (step 104). However, if the information provided by the payment network provider is sufficient to determine and resolve the cause, works directed to remove the issue are put in place (step 113) resulting in the issue being resolved (step 114) at the acquirer side or in cooperation with the payment network provider and/or issuer.

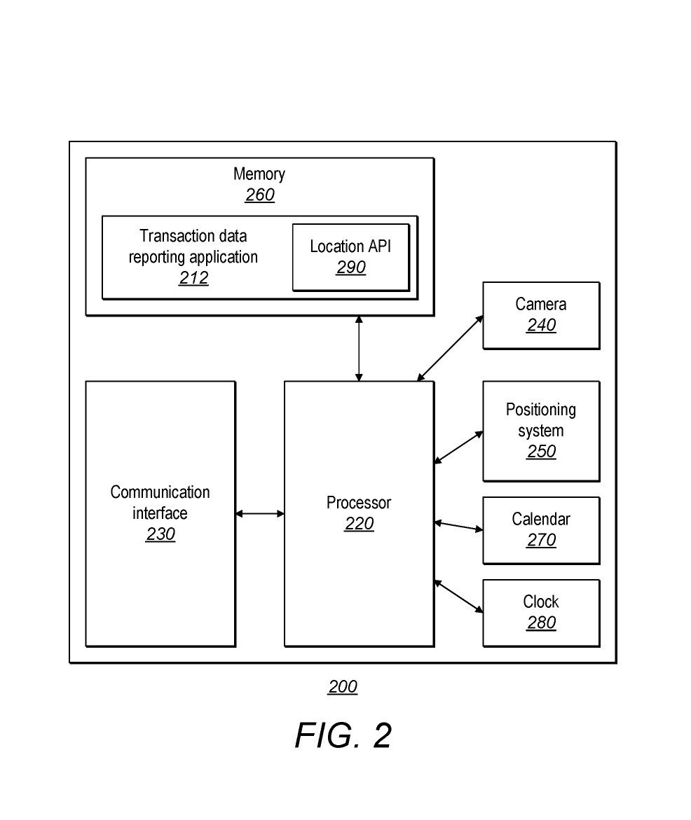

FIG. 2 shows schematic representation of a mobile electronic device 200 capable of performing the methods and steps described herein in respect to some embodiments of the disclosure. The mobile electronic device 200 may be, a smartphone, or a tablet or another device capable of cellular or wireless communication (e.g., via Wi-Fi, GPRS, 3G or other protocols).

The mobile electronic device 200 comprises one or more processors 220 operatively coupled to memory 260 and is configured to run an operating system, for example, an iOS or Android OS. The memory 260 may be any computer readable non-transitory medium, or the like, configured to store data, code, or other information, including any number of applications or programs for operating the mobile electronic device 200. The application and/or programs generally comprise computer-executable instructions/code which, when executed (operated, or the like) by the processor 220, implement the functions of the mobile electronic device 200 described herein. For example, the mobile electronic device 200 has a transaction data reporting application 212 installed thereon and maintained in the memory 260.

The mobile electronic device 200 may comprise a number of additional components engageable by the transaction data reporting application 212 for performing functions described herein. For example, the mobile electronic device may include a camera 240 which may be used to capture photo(s) relating to a payment transaction, e.g., a photo of a payment terminal. The mobile electronic device 200 may further comprise a positioning system 250, such as a Global Positioning System (GPS) or a Wi-Fi positioning systems or a combination of both, that allows the location of the mobile electronic device 200 to be ascertained. Additionally, the mobile electronic device 200 typically comprises an inbuilt calendar 270 and clock feature 280, whose data may be used by the transaction data reporting application 212 when generating transaction reports.

The mobile electronic device 200 also comprises a communication interface 230, such as a touchscreen, that is suitable for displaying a graphical user interface (GUI), for example, for engaging the transaction data reporting application 212, and receiving user input into the GUI.

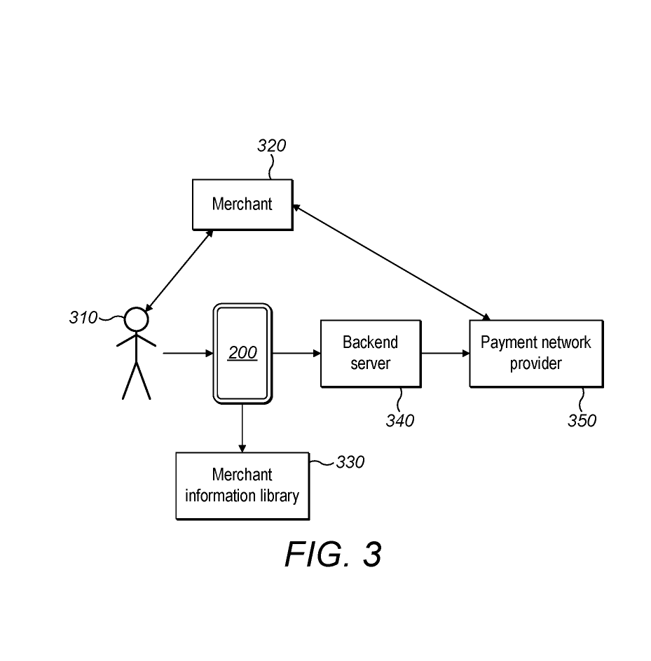

FIG. 3 shows an example of a system for automatically reporting an issue relating to a transaction to a customer services team.

The system includes a mobile electronic device 200, as described with reference to FIG. 2, a user 310, a merchant 320, a merchant information library 330 stored on a remote server, a backend server 340 used by a payment network provider 350 to process payment transaction reports generated by the mobile electronic device 200, and the payment network provider 350.

Transactions to which the present disclosure relates take place between the user 310 and a merchant 320. The merchant 320 can be a retailer, a cash delivery point, or another entity that is able to accept payments through the payment network provider 350.

The payment network provider 350 provides an infrastructure allowing payments to be processed involving banking institutions associated with the user 310 and the merchant 320. The payment transactions from the user 310 to the merchant 320 may be initiated using a payment card, or an electronic payment device, such as a secure payment enabled smart phone.

When an issue occurs with a transaction, the user 310 is able to report the issue to the payment network provider for investigation using the mobile electronic device 200. In some examples, the mobile electronic device 200 is a smart phone that is used to initiate the payment transaction.

In order to gather data for inclusion in the transaction issue report, the mobile electronic device 200 accesses the merchant information library 330 in order to automatically retrieve data relating to the merchant.

The merchant information library 330 is a database stored on a remote server. The merchant information library 330 comprises information relating to merchants that belong to the payment network, including the names and addresses of the merchants. The merchant information library 330 is in two way communication with the mobile electronic device 200 over an internet connection and may receive data from the mobile electronic device 200 and send data to the mobile electronic device 200.

When the transaction issue report has been generated on the mobile electronic device 200, it is sent to the backend server 340 of the payment network provider 350. In some examples, the transaction issue report is re-directed to a particular individual for inspection of the report. In other examples, the transaction issue report is automatically processed to extract information for storage on a database operated by the payment network provider 350.

Described below is a detailed description of how the elements of the system interact to produce and transmit a transaction issue report message.

Initiation

Upon noting an issue with a payment transaction, such as the failure of the transaction to be successfully processed, the user 310 may launch or access the transaction data reporting application 212 stored in the memory 260 of the mobile electronic device 200.

In some examples the transaction data reporting application 212 is automatically launched in response to a transaction issue. For example, this may occur when the transaction is performed through an electronic wallet stored on the mobile electronic device 200. The electronic wallet launches or invokes the transaction data reporting application 212 on recognizing an issue with a payment transaction.

The transaction data reporting application 212 then proceeds to acquire data relating to the transaction issue through a combination of user input and automated processes. The functionalities of the transaction data reporting application 212 are discussed below in greater detail in relation to types of data that the transaction data reporting application 212 acquires.

To ensure compliance with local regulations concerning data acquisition, usage and privacy, the transaction data reporting application 212 and the backend server 340 can be configured such that any data gathered will be processed fairly, lawfully and for the stated purposes only and the consent of the user may be required.

Merchant Information

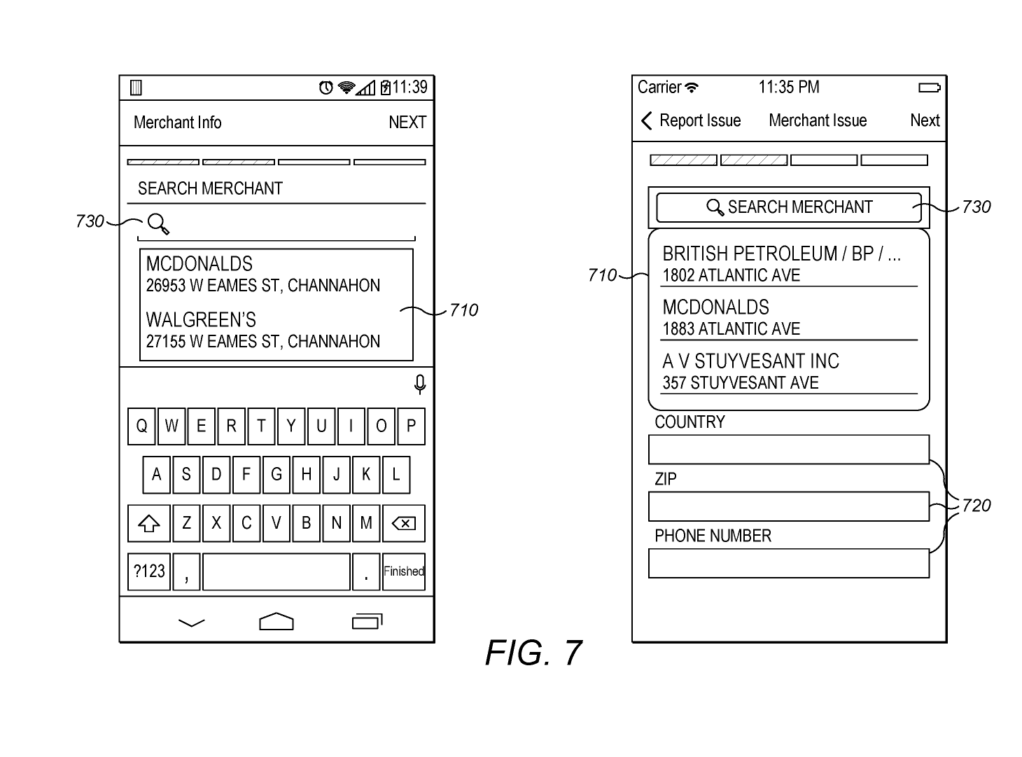

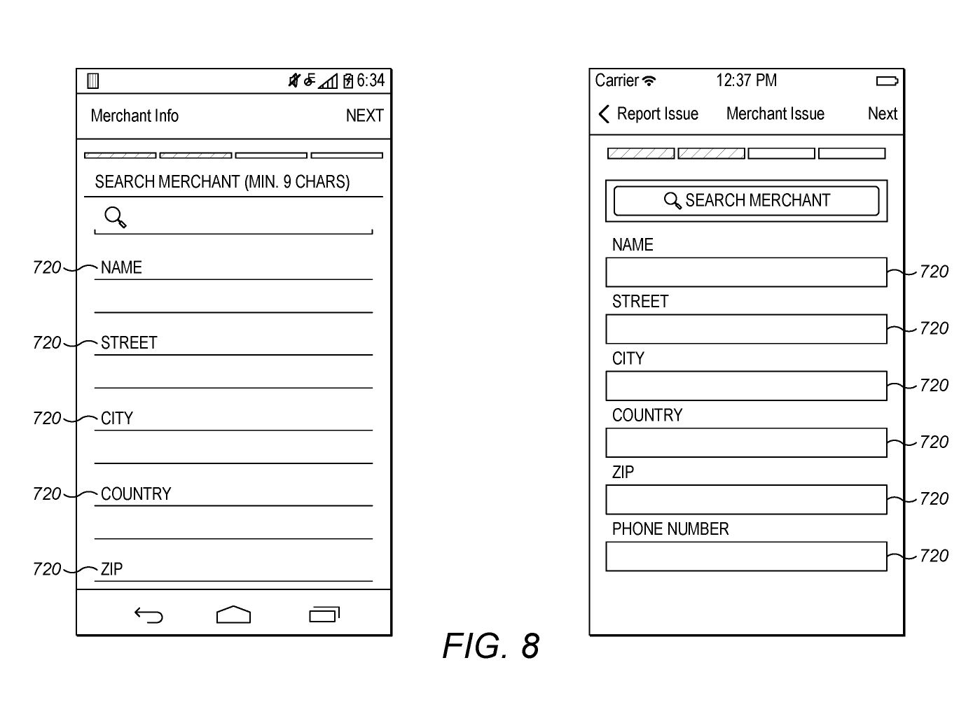

Described below with reference to FIGS. 7 and 8 are processes for obtaining information regarding the merchant 320.

The transaction data reporting application 212 can be configured to acquire data relating to the merchant 320 involved in the transaction issue. The mobile electronic device 200 uses the transaction data reporting application 212 to provide, through the communication interface 230, a user 310 with a number of merchant data input fields 720 relating to the merchant 320 involved in the transaction. The merchant data input fields 720 may be populated automatically or manually by the user 310.

The merchant data input fields 720 typically includes the name and address of the merchant 320. This allows the user 310 to identify the merchant 320 with whom the transaction issue arose. In some embodiments the merchant data input fields 720 correspond to the name of the merchant and the street, city, country, ZIP, and phone number of the merchant's address.

If the transaction data reporting application 212 has access to the mobile electronic device's positioning system 250, the transaction data reporting application 212 determines the position of the mobile electronic device 200 by requesting location data from the positioning system 250 of the mobile electronic device 200. On certain operating systems it may be necessary for the user to confirm that the transaction data reporting application 212 has permission to access the positioning system 250 of the mobile electronic device 200.

The process of determining the location of the mobile electronic device 200 may be time consuming. For this reason, in some embodiments, the process is initiated as soon as the transaction data reporting application 212 is launched or accessed by the user 310.

The transaction data reporting application 212 then issues a request to the merchant information library 330 for merchant data relating to merchants within a predetermined distance of the location of the mobile electronic device 200, the location of the mobile electronic device 200 being determined using the location data provided by the positioning system 250.

In response to the request, the transaction data reporting application 212 receives merchant data identifying merchants within the predetermined distance of the mobile electronic device 200. In some embodiments, the merchant data includes at least the names and addresses of merchants provided to the mobile electronic device 200.

Based on the merchant data, the transaction data reporting application 212 generates a list of merchants 710, which it then displays to the user 310. The user 310 is prompted to select a merchant 320 from the list of merchants 710. In some embodiments, the transaction data reporting application 212 is configured to allow the user 310 to filter the list of merchants 710, by entering one or more letters from the merchant's address in a search merchant field 730. When the user 310 selects a merchant from the list of merchants 710, the merchant data input fields 720 are auto-populated based on the merchant data corresponding to the selected merchant 320.

In some embodiments the process of requesting merchant data is performed using a location API 290, such as the MasterCard™ locations API. The location API 290 calls the merchant information library 330 (server, or the like) and requests data for merchants within a certain distance of the location of the mobile electronic device 200 as defined by the location data provided by the positioning system 250. The transaction data reporting application 212 receives an array of data comprising information corresponding to the names and addresses of a number of local merchants from the merchant information library 330.

In some embodiments, with each call the location API 290 returns data associated with a pre-defined number of merchants within a pre-defined distance (e.g., up to 25 merchants within a 10 mile radius) of the position of the mobile electronic device 200 as defined by the location data provided by the positioning system 250. In some embodiments, the transaction data reporting application 212 calls the location API 290 a pre-defined number of times (e.g., four times) to retrieve data relating to a large numbers of merchants for user selection. For example, if details are retrieved for 25 merchants with each call, details for 100 merchants can be retrieved by calling the location API 290 four times.

If the user 310 has not enabled the transaction data reporting application 212 to access the mobile electronic device's positioning system or the user's location cannot be determined by the positioning system 250, the transaction data reporting application 212 will not attempt to fetch merchant data.

In the case that the transaction data reporting application 212 does not attempt to fetch merchant data, merchant data input fields 720 may be filled manually by the user 310.

In some embodiments, the user 310 is required to input an alpha numeric value into the “phone number”, “name”, “street”, “city”, “country” and “ZIP” fields in order to populate the merchant data input fields 720 manually. Some of the fields, for example the “phone number” field, may be left empty.

Get Card Details

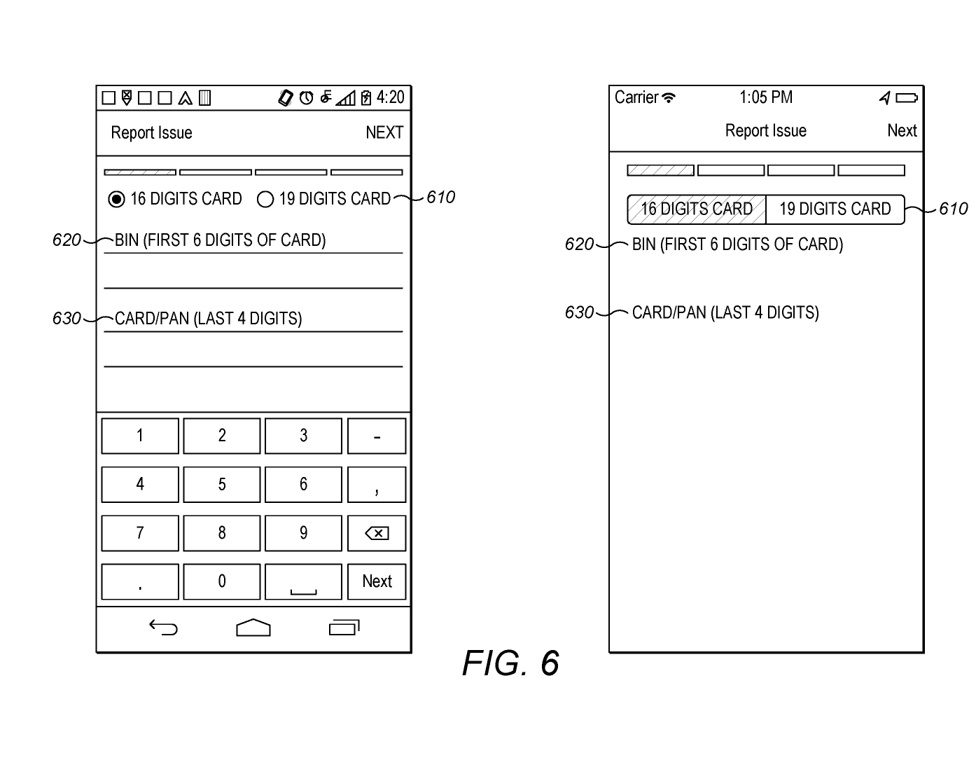

Described below with reference to FIG. 6 are processes for obtaining card identification information for the payment card used in the transaction.

In some embodiments, the transaction data reporting application 212 prompts the user 310 to input data identifying an account number used during the transaction. In some embodiments these prompts are provided to the user 310 while the process of determining the location of the mobile electronic device 200 is on-going.

For example, the transaction data reporting application 212 may prompt the user 310 to select whether to input data corresponding to a 16 digit card or a 19 digit card associated with the account. The default selection may, for example, correspond to a 16 digit card.

In either case the user 310 is provided with two input fields 620 and 630, corresponding to a BIN (Bank Identification Number—the first six digits of the card) and a Card/PAN (Primary Account Number—the last four digits of the card) respectively. If the user 310 enters fewer than 6 digits for the BIN field 620, the transaction data reporting application 212 will display a message for invalid BIN. If the user 310 enters fewer than 4 digits for the Card/PAN field 630, the transaction data reporting application 212 will display a message for invalid PAN.

If these fields 620 and 630 have been entered into the transaction data reporting application 212 on a previous occasion, the respective data input may be stored in the memory 260 of the mobile electronic device 200 and used to auto-populate these fields 620 and 630. In some embodiments, the details corresponding to several cards can be stored in the memory 260 of the mobile electronic device 200 at any one time and the transaction data reporting application 212 can be configured to allow the user 310 to select one of the pre-stored accounts.

Transaction Details

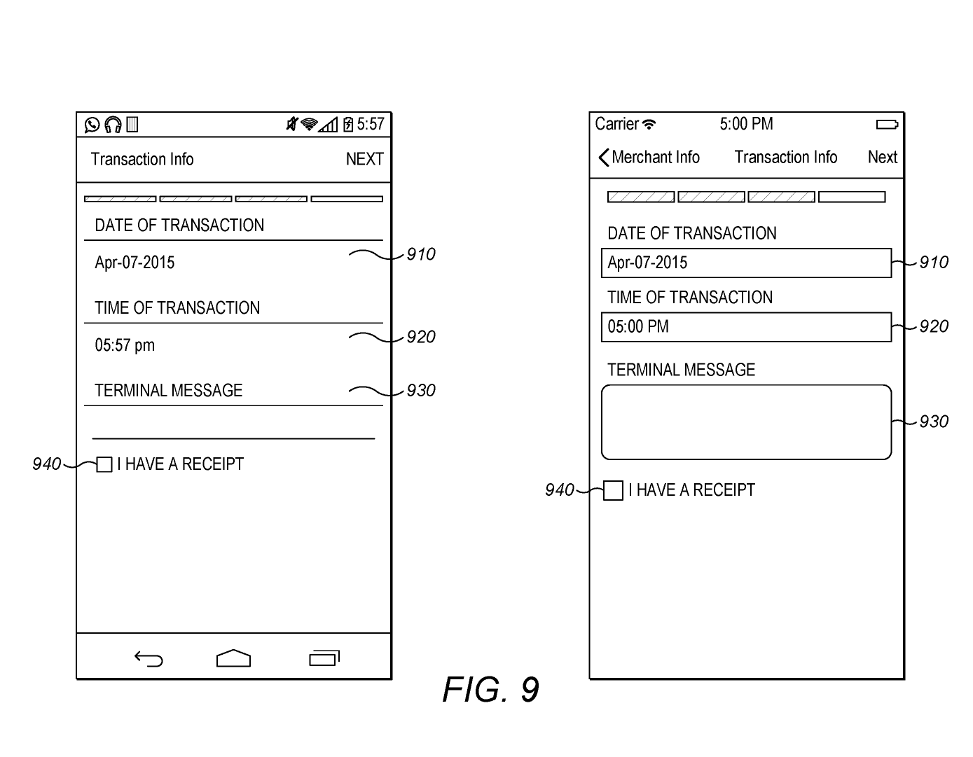

Described below with reference to FIGS. 9, 10 and 11 are processes for obtaining further information relating to the transaction.

The transaction data reporting application 212 provides the user with transaction input fields 910, 920, 930 and 950.

In some embodiments the transaction input fields are a transaction date field 910, a transaction time field 920 and a terminal message field 930.

These data are vital in order to identify the transaction when has a large transaction volume. This is important when locating the relevant transaction and determining the cause of the failure, for example, by associating a failed transaction with technical issues experienced at the time of the transaction.

The transaction data reporting application 212 may access the inbuilt calendar 270 in the mobile electronic device 200 and obtain the current date. This enables the transaction data reporting application 212 to automatically set the transaction date field 910 as the current date. In some embodiments, the automatically set transaction date can be manually changed by the user 310. The format for the data input into the transaction date field 910 is predetermined. For example, in some embodiments, the required format for the transaction date field is “MMM-DD-YYYY”, (e.g., Feb. 2, 2015).

The transaction data reporting application 212 may also access the inbuilt clock 280 in the mobile electronic device 200 and obtain the current time. This enables the transaction data reporting application 212 to automatically populate the transaction time field 920 with the current time. In some embodiments, the automatically set transaction time can be manually changed by the user 310. The format for the data input into the transaction time field 920 is predetermined. For example, in some embodiments, the required format for the transaction time field 920 is “HH:mm a”, (e.g., 12:35 pm).

The user 310 is requested to enter in a terminal message field 930 a description of a message provided at the terminal used to perform the attempted transaction.

The user 310 is also given the option to indicate that the user 310 has a receipt of the transaction, for example by ticking a corresponding checkbox 940. If the user 310 selects this checkbox 940, a further receipt message field 950 is presented in which the user 310 may input text corresponding to the text of the receipt.

In some examples the transaction data reporting application 212 prompts the user 310 to enter additional information relating to the transaction. In some examples the user is able to provide an image of the point-of-interaction (POI) terminal and/or an image of a receipt issued with the transaction. The POI location is the location at which the transaction occurs, whether a physical location, a website, a mail order form, or another place where a customer provides payment information. The POI terminal is the end point of the POI with which the user directly interacts. For example, the POI terminal could comprise a card reader device or a cash point. Depending on the POI, the POI terminal may present the user with a message upon termination of a transaction due to an issue. The message may include, for example, a code corresponding to a known fault condition. Details of the message can be helpful in diagnosing the cause of the transaction issue. The images of the POI terminal and the receipt may be captured using the camera 240 which, in some examples, is invoked directly by the transaction data reporting application 212. In some examples the mobile electronic device accesses camera control software and uses the camera control software to initiate a camera of the mobile electronic device in order to obtain an image of the POI or receipt.

In some examples, the mobile electronic device 200 has text and/or image recognition software stored on its memory. The images of the POI and the receipt may be processed by the text/image recognition software to automatically populate the terminal message field 930 and/or receipt message field 950.

In some examples the transaction data reporting application 212 provides the user 310 with a merchant comment field 1030 for entering comments provided by the merchant 320 in person. In some examples the transaction data reporting application 212 provides the user 310 with an additional comments field 1040 for entering additional comments relating to the transaction (e.g., anything that the user 310 may perceive as relevant to the transaction).

Report The Issue

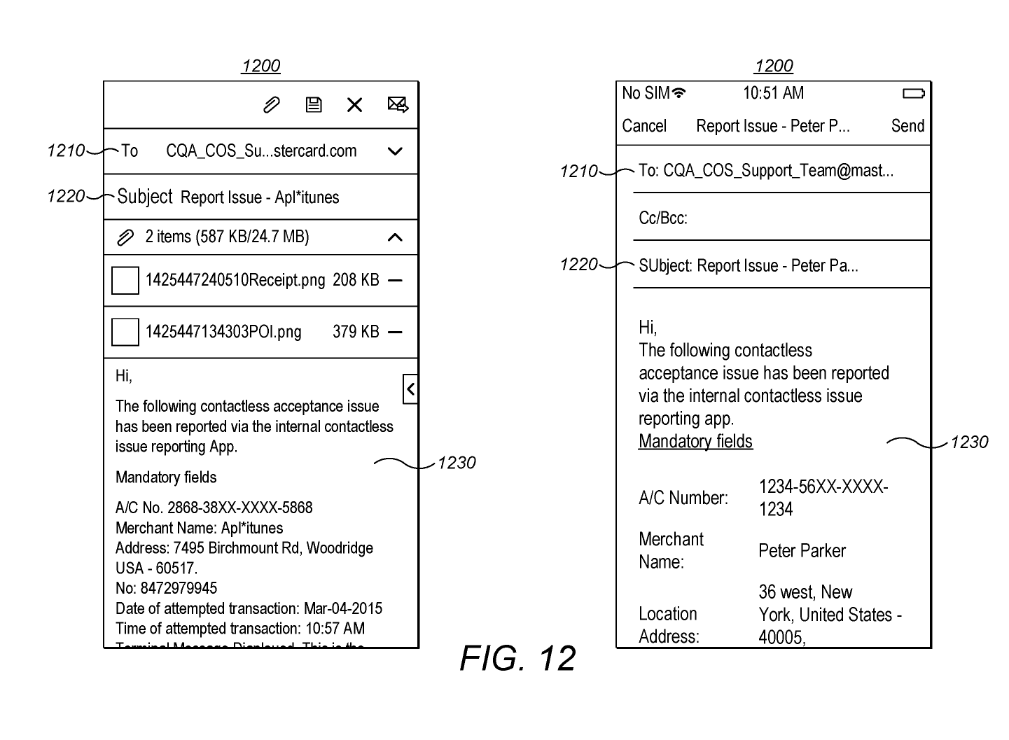

Described below with reference to FIG. 12 is a process for generating a transaction report message.

The transaction data reporting application 212 combines the data acquired through user input and automatic acquisition steps and processes the data to generate a reporting message. The reporting message may be presented in the body 1230 of an email message. The subject title 1220 is automatically filled in a predetermined format. The recipient address 1210 is automatically filled to correspond with the intended recipient.

The reporting message in the body 213 of the email comprises the acquired data formatted according to a predetermined format. The predetermined format may require that the acquired data is presented in a specified order. The predetermined format may further require that the acquired data is presented in a specified form; for example, with the PAN number comprising 16 numerical digits broken down into four blocks of four digits separated by dashes.

When the transaction issue report message is received by the backend server 340 of the payment network provider 350, the formatted information is extracted and stored in a transaction issue database located on a remote server. Transaction issues can then be monitored and dealt with efficiently using the comprehensive database of transaction issues stored in the transaction issue database.

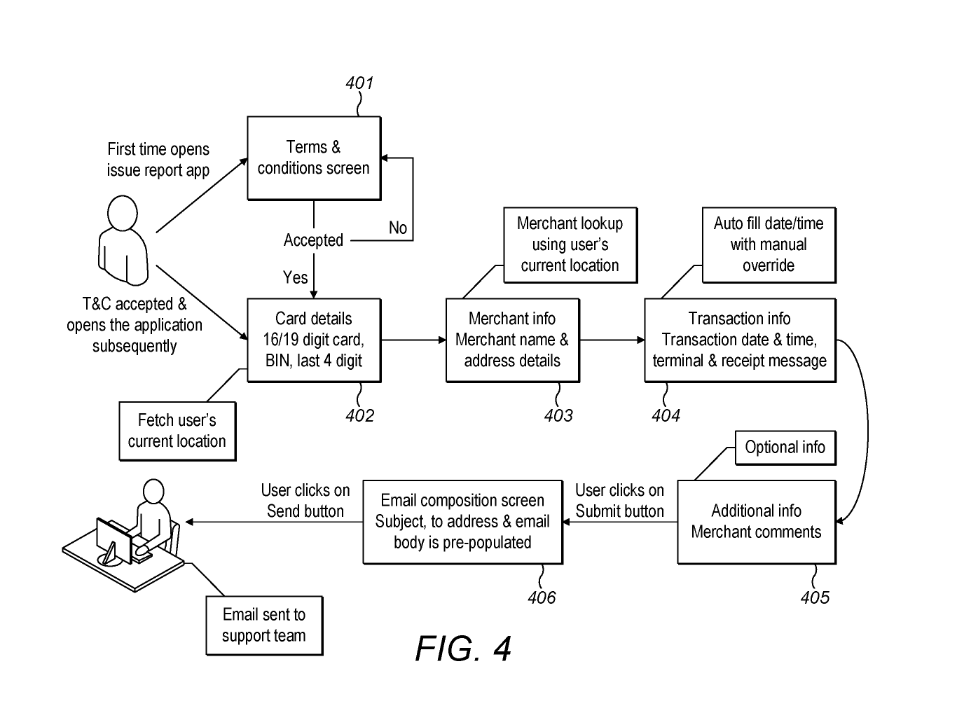

FIG. 4 shows a flow diagram detailing the functions of the transaction data reporting application 212 and the order in which they are performed in one embodiment of the disclosure. Specifically, it illustrates an example of a sequence of steps by which the transaction data reporting application 212 can acquire data relating to the transaction. However, it should be understood that the order of the steps is not essential to the process and that steps may be omitted or added without altering the nature of the process.

When the transaction data reporting application 212 is launched for the first time, the user 310 is presented with a Terms & Conditions Screen 401. If the user 310 inputs an acknowledgement that she/he accepts the terms and conditions presented on the Terms & Conditions Screen 401, the user 310 is then presented with a Card Details 402 screen. When the transaction data reporting application 212 is launched on subsequent occasions, the user 310 is taken to the Card Details 402 screen immediately, instead of first to the Terms & Conditions screen.

At the Card Details screen 402, the transaction data reporting application 212 requests location data from the positioning system 250 of the mobile electronic device 200. While this process runs in the background, the user 310 is prompted to input details of his/her payment card, as described in more detail in reference to FIG. 3 and FIG. 6.

The user 310 is then taken to the Merchant Info 403 screen. The transaction data reporting application 212 then requests and receives merchant data relating to merchants within the vicinity of the mobile electronic device 200. A list of merchants 710 is generated from the merchant data and presented to the user. When the user 310 selects a merchant from the list of merchants 710 generated from the merchant data, the merchant data input fields are auto-populated based on the merchant data corresponding to the selected merchant 320, as described in more detail with reference to FIGS. 3, 7 and 8.

The user 310 is then taken to the Transaction Info 404 screen. The time field 920 and date field 910 are automatically populated and the user 310 may input a terminal message and a receipt message, as described in more detail with reference to FIGS. 3, 9 and 10.

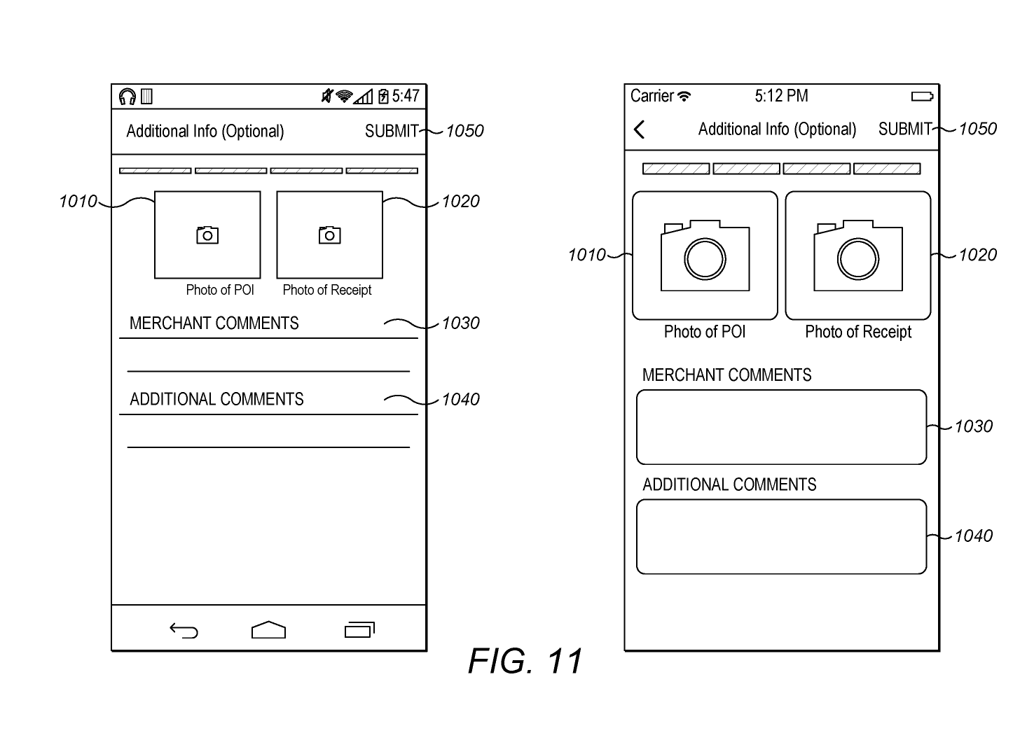

The user 310 is then taken to the Additional Info 405 screen. The user 310 is provided the option to provide a photo of the POI (point-of-interaction) or a photo of the receipt. The user 310 is also provided with fields for inputting merchant comments and additional comments, as described in more detail with reference to FIGS. 3 and 11.

The user 310 is then able to submit the data by clicking on a submit button 1050, which prompts the transaction data reporting application 212 to open an Email Composition Screen 406. An email is generated with an automatically filled subject 1220, recipient address 1210 and main body 1230, as described in more detail with reference to FIGS. 3 and 12. The user 310 may then send the email, which comprises formatted data relating to the payment transaction issue, to the backend server 340 of a payment network provider.

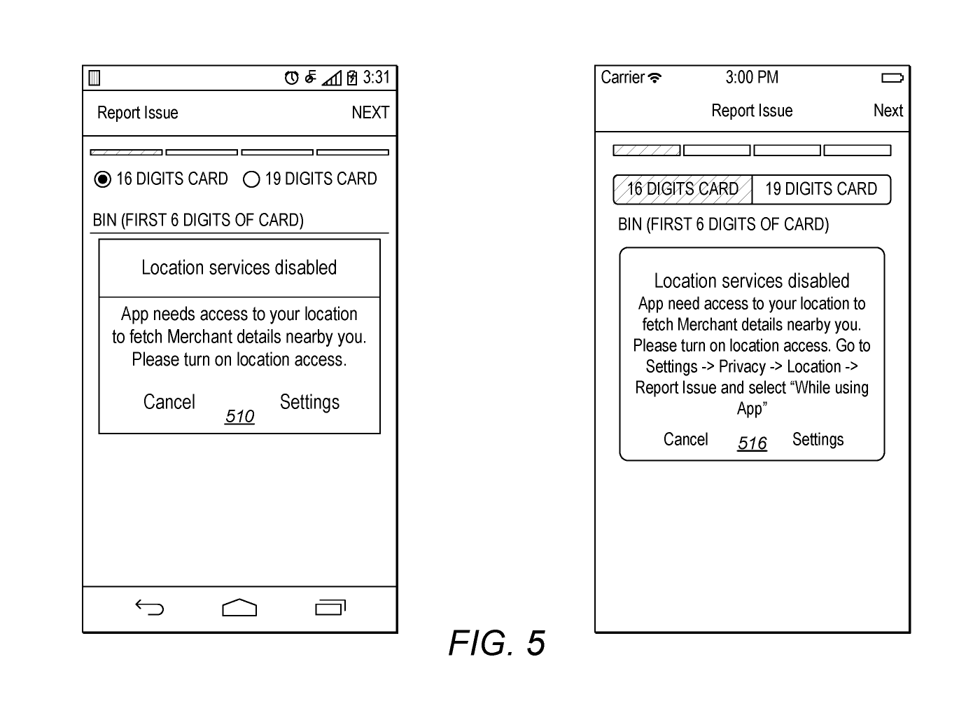

FIGS. 5 to 12 show examples of the graphic user interfaces that can be used in the methods, systems and devices described in the present disclosure. Although some of the figures are referred to above, further details are disclosed below with reference to each figure individually.

FIG. 5 shows the graphic user interface of the transaction data reporting application 212, in examples using iOS and Android operating systems, during one process used in the transaction data acquisition method shown in FIG. 3. The user interface 230 requests, at 510 and 516 in FIG. 5, that a user 310 give the transaction data reporting application 212 permission to access the positioning systems 250 of the mobile electronic device.

FIG. 6 shows the graphic user interface of the transaction data reporting application 212, in examples using iOS and Android operating systems, during Card Details 402 process used in the transaction data acquisition system shown in FIG. 3. The user 310 is given the option, at 610, to select whether to input data relating to a 16 digit card or a 19 digit card. The user 310 is presented with two fields 620 and 630 in which data may be input corresponding to a BIN number and a CARD/PAN number respectively.

FIG. 7 shows the graphic user interface of the transaction data reporting application 212, in examples using iOS and Android operating systems, during the Merchant Info 403 process used in the transaction data acquisition system shown in FIG. 3. The user 310 is provided with a list of merchants 710 for which merchant data has been received. If a merchant 320 is selected from the list of merchants 710, the merchant data input fields 720 will be auto-populated with the merchant information corresponding to the selected merchant 320. The list of merchants 710 is presented to the user 310 when the transaction data reporting application 212 has received the merchant data from the merchant information library 330 and generated a list of merchants 710.

While the merchant data is being received and the list of merchants 710 is being generated, a progress indicator is displayed on “merchant info” screen.

When the list of merchants 710 has been presented to the user 310, the user 310 can input search characters of a merchants name in order to search the specific merchant 320 from within the list of merchants 710. This provides a better user experience then a scrolling list. As the characters are entered, the list gets reduced by matching the characters with a merchants name.

Once the user 310 selects any merchant from the list of merchants 710, the merchant data fields 720 are populated with merchant data corresponding to the selected merchant 320. If the user 310 again selects the search field 730, the list of merchants 710 appears once again. The search characters are matched only with the merchant's name and are not matched with the other parts of the merchant's address.

FIG. 8 shows the graphic user interface of the transaction data reporting application 212, in examples using iOS and Android operating systems, as used by the transaction data acquisition system shown in FIG. 3. If no merchant data is received or if location services cannot be accessed, the user 310 is invited to input the merchant data in the relevant fields 720 manually.

FIG. 9 shows the graphic user interface of the transaction data reporting application 212, in examples using iOS and Android operating systems, as used by the transaction data acquisition system shown in FIG. 3. The date of transaction fields 910 and time of transaction fields 920 are automatically populated with the current date and time respectively. A terminal message 930 may be entered manually. If the user 310 has a receipt, s/he can select the option 940 confirming that this is the case.

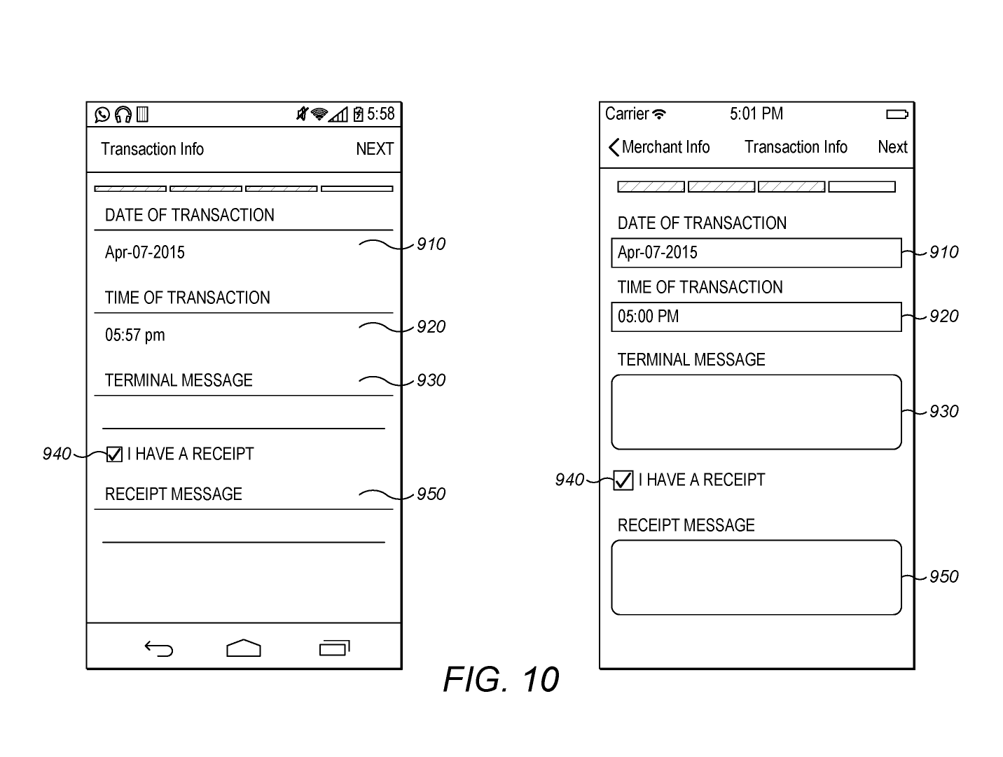

FIG. 10 shows the graphic user interface of the transaction data reporting application 212, in examples using iOS and Android operating systems, as used by the transaction data acquisition system shown in FIG. 3. If the user 310 confirms that she/he has a receipt, the user may enter text corresponding to a receipt message into a receipt message data field 950.

FIG. 11 shows the graphic user interface of the transaction data reporting application 212, in examples using iOS and Android operating systems, as used by the transaction data acquisition system shown in FIG. 3. The user is presented with the option may enter a photo of the POI 1010 or of the receipt 1020 from the mobile electronic device's memory 260. The user 310 is also presented with a merchant comments field 1030 and an additional comments field 1040.

The user 310 is presented with a submit button 1050. The submit button 1050 will send all screen's information to mail composer 1200 (shown in FIG. 12) from where an email including the transaction data relating to failed payment transactions can be sent to a support team for a payment network provider 350.

FIG. 12 shows the graphic user interface of a mail composer used, in examples using iOS and Android operating systems, during as used by the transaction data acquisition system shown in FIG. 3. The subject field 1220 and the address field 1210 are auto-populated with predetermined details. The text body 1230 is auto-populated with data acquired from the previous steps and processed into a pre-set format.

By making the input certain data fields mandatory, the transaction data reporting application 212 ensures that sufficient information is provided to the payment network provider to allow successful resolution of a transaction issue. Thus, the requirement for multiple back and forth communications between the issuer and the payment network provider (and also the issuer and cardholder) can be eliminated. By providing the transaction report directly to the payment network provider, the payment provider is enabled to begin to investigate and address an issue promptly, eliminating any delays caused by the need to request/wait on additional data. The direct communication of necessary information in a pre-set format in a single message reduces the amount of network resources required to transmit and store the information required in a transaction issue when compared to the conventional approach.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, CDs (compact discs), DVDs (digital versatile discs), or other media that are capable of storing code and/or data.

The methods and processes can also be partially or fully embodied in hardware modules, apparatuses, or firmware, so that when the hardware modules or apparatuses are activated, they perform the associated methods and processes. The methods and processes can be embodied using a combination of code, data, and hardware modules or apparatuses.

Examples of processing systems, environments, and/or configurations that may be suitable for use with the embodiments described herein include, but are not limited to, embedded computer devices, personal computers, server computers (specific or cloud (virtual) servers), hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like. Hardware modules or apparatuses described in this disclosure include, but are not limited to, application-specific integrated circuits (ASICs), field-programmable gate arrays (FPGAs), dedicated or shared processors, and/or other hardware modules or apparatuses.

The order of execution or performance of the operations in the embodiments illustrated and described herein is not essential, unless otherwise specified. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

While the present disclosure has been described in terms of various specific embodiments, the skilled person would recognize that the present disclosure can be practiced with modification within the spirit and scope of the claims.

The functions and/or steps and/or operations included herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Further, it should be appreciated that one or more aspects of the present disclosure transform a general-purpose computing device into a special-purpose computing device when configured to perform the functions, methods, and/or processes described herein.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of collating and transmitting information relating to a payment transaction, the method comprising:
determining, at a mobile electronic device, a current location of the mobile electronic device;
obtaining, by the mobile electronic device, merchant data concerning one or more merchants located within a predetermined distance of the current location of the mobile electronic device;
generating, by the mobile electronic device, a list of merchants based on the merchant data;
receiving, through a user interface of the mobile electronic device, a user selection of a merchant from the list of merchants;
requesting, through a prompt presented on a display of the mobile electronic device, input data from a user in relation to a plurality of aspects of the payment transaction;
receiving, through the user interface of the mobile electronic device, input data provided by the user in relation to the plurality of aspects relating to the payment transaction, wherein for each aspect of the plurality of aspects relating to the payment transaction the user interface is configured to require the input data to be in a predetermined format;
generating, by the mobile electronic device, a transaction report, based on the input data and merchant data associated with the merchant selected by the user, in a format compliant with requirements of a backend server; and
transmitting the transaction report from the mobile electronic device towards the backend server for automatic processing.

2. The computer-implemented method of claim 1, further comprising: determining a current date automatically using an inbuilt calendar feature of the mobile electronic device and determining a current time using an inbuilt clock feature of the mobile electronic device, and wherein the transaction report further comprises data indicating the determined current date and the determined current time.

3. The computer-implemented method of claim 1, wherein:
obtaining merchant data comprises transmitting a merchant information data request to a remote server hosting a database comprising merchant information data, the merchant information data request comprising data identifying the current location of the mobile electronic device; and
receiving from the remote server, in response to the merchant information data request, merchant data comprising a name and an address for each of one or more merchants within a predetermined distance of the current location of the mobile electronic device identified in the merchant information data request.

4. The computer-implemented method of claim 1, further comprising presenting the list of merchants to the user as a drop down list on a display of the mobile electronic device; and
wherein the user selection of a merchant from the list of merchants is received in response to presenting the list of merchants to the user.

5. The computer-implemented method of claim 1, wherein generating the transaction report comprises generating a report message wherein a main body of the report message comprises the input data and the merchant data associated with the merchant selected by the user, the selected input data and the merchant data being arranged according to a predetermined format.

6. The computer-implemented method of claim 5, wherein the predetermined format of the report message defines the order in which the input data and the merchant data are presented in the report message.

7. The computer-implemented method of claim 6, wherein the predetermined format of the report message further determines the form in which the data relating to each aspect of the payment transaction is presented in the report message.

8. The computer-implemented method of claim 1, further comprising:
prompting the user, via the user interface, to take a photograph of the point of interaction terminal;
accessing a camera control software comprised by the mobile electronic device; and
initiating, using the camera control software, a camera of the mobile electronic device in order to obtain an image of the point of interaction terminal;
wherein the transaction report further comprises the obtained image of the point of interaction terminal.

9. The computer-implemented method of claim 8, further comprising processing the image of the point of interaction terminal or the receipt using text recognition software stored on the mobile electronic device to extract text data corresponding to writing displayed on the point of interaction terminal, and wherein the transaction report further comprises the text data.

10. The computer-implemented method of claim 1, further comprising:
prompting the user, via the user interface, to take a photograph of a receipt issued upon failure of the payment transaction;
accessing a camera control software comprised by the mobile electronic device; and
initiating, using the camera control software, a camera of the mobile electronic device in order to obtain an image of the receipt;
wherein the payment transaction report further comprises the obtained image of the receipt.

11. The computer-implemented method of claim 1, wherein the mobile electronic device is a smart phone.

12. The computer-implemented device of claim 1, wherein the transaction report is in the form of an email message addressed to a predetermined recipient address.

13. The computer-implemented method of claim 1, wherein the predetermined format in which the input data is required comprises at least one of: a BIN number having exactly six digits identifying a payment card used in the payment transaction; a PAN number having exactly four digits identifying the payment card used in the payment transaction; an alphanumeric sequence corresponding to a message displayed by a terminal used in the payment transaction; an alphanumeric sequence corresponding to a message appearing on a receipt issued during the payment transaction; an alphanumeric sequence corresponding to comments provided by the merchant involved in the payment transaction; and/or an alphanumeric sequence corresponding to additional comments provided by the user.

14. A mobile electronic device comprising a communication node, a positioning system, a display, and a user interface wherein the mobile electronic device is configured to:
determine a current location of the mobile electronic device using the positioning system;
obtain merchant data concerning one or more merchants located within a predetermined distance from the current location of the mobile electronic device;
generate a list of merchants based on the merchant data;
receive, through the user interface, a user selection of a merchant from the list of merchants;
request, through a prompt presented on the display of the mobile electronic device, input data from a user in relation to a plurality of aspects of the payment transaction;
receive, through the user interface, input data provided by the user in relation to the plurality of aspects relating to the payment transaction, wherein for each aspect of the plurality of aspects relating to the payment transaction the user interface is configured to require the input data in a predetermined format;
generate a transaction report based on the input data and merchant data associated with the merchant selected by the user, in a format compliant with requirements of a backend server; and
transmit the transaction report from the communication node towards the backend server for automatic processing.

15. The mobile electronic device of claim 14, wherein the mobile electronic device comprises an inbuilt calendar feature and an inbuilt clock feature, and wherein the mobile electronic device is further configured to:
determine a current date automatically using an inbuilt calendar feature of the mobile electronic device and determining a current time using an inbuilt clock feature of the mobile electronic device, and wherein the transaction report further comprises data indicating the determined current date and the determined current time.

16. The mobile electronic device of claim 14, wherein:
obtaining merchant data, comprises transmitting a merchant information data request to a remote server hosting a database comprising merchant information data, the merchant information data request comprising data identifying the current location of the mobile electronic device; and
receiving from the remote server, in response to the merchant information data request, merchant data comprising a name and an address for each of one or more merchants within a predetermined distance of the current location of the mobile electronic device identified in the merchant information data request.

17. The mobile electronic device of claim 14, wherein the mobile electronic device is further configured to present the list of merchants to the user as a drop down list on the display;
wherein the user selection of a merchant from the list of merchants is received in response to presenting the list of merchants to the user.

18. The mobile electronic device of claim 14, wherein generating the transaction report comprises generating a report message wherein a main body of the report message comprises the input data and the merchant data of the merchant selected by the user, the input data and the merchant data being arranged according to a predetermined format.

19. The mobile electronic device of claim 18, wherein:
the predetermined format of the report message defines the order in which the input data and merchant data are presented in the report message; and
the predetermined format of the report message further defines the form in which the data relating to each aspect of the payment transaction is presented in the report message.

20. The mobile electronic device of claim 14, wherein the mobile electronic device is further configured to:
prompt the user, via the user interface, to take a photograph of a receipt issued upon failure of the payment transaction or a point of interaction terminal;
access a camera control software comprised by the mobile electronic device; and
initiate, using the camera control software, a camera of the mobile electronic device in order to obtain an image of the receipt;
wherein the transaction report further comprises the image of the receipt.
